(19) United States
(12) Patent Application Publication
(10) Pub. No.: US 2007/0016958 A1
(43) Pub. Date: Jan. 18, 2007

(54) Allowing any computer users access to use only a selection of the available applications

(75) Inventors: Smita Bodepudi, Austin, TX (US); Michael D. Hinegardner, Round Rock, TX (US); Murali Neralla, Austin, TX (US); Shirish S. Pargaonkar, Round Rock, TX (US); Prasad V. Potluri, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 11/179,237

(22) Filed: Jul. 12, 2005

(51) Int. Cl. H04L 9/32; H04N 7/16; G06F 17/30; G06F 7/04; G06K 9/00; H03M 1/68; H04K 1/00; H04L 9/00

(52) U.S. Cl. 726/27; 726/28; 726/29; 726/30

(57) ABSTRACT

A computer system operates in normal mode where all applications and files are accessible to an authorized user, where an authorized user enters a required log in to access all applications. When a trigger to change the control access from normal mode to selective lock mode is detected, access to the applications and files is blocked and the content within the user interface is cleared to initiate the selective lock mode. Next, content is added to the user interface including a folder with only a selection of the applications each accessible through a separate selectable link, where the selectable links are designated in the particular folder by an authorized user during normal mode. During selective lock mode, any user may only select to open one of the selection of applications by selecting a displayed selectable link for the application. Responsive to a selection of a selectable link, a wrapper function is called that opens the application, wherein any user is enabled to fully access only the wrappered application and the wrapper blocks access to the remainder of the computer system, such that during selective lock mode any user is presented with access, without first logging in, to a fully functioning version of each of the selection of applications designated by the authorized user in the particular folder.

### BACKGROUND OF THE INVENTION

1. Technical Field

The present invention relates in general to improved data processing systems and in particular to limiting use of a computer system by a any user. Still more particularly, the present invention relates to allowing any computer users access to use only a selection of the available applications at a computer system without requiring a log in.

2. Description of the Related Art

Computer users today often have access to and use of many different computer systems on a single day. In addition, many computers today are often accessed and used by more than one user on a consistent basis. Because of the diversity of users that may access and attempt to use a particular computer system, an owner of a computer system may desire that other users of the computer system or unauthorized users of the computer system only receive limited use, if any, of the computer system.

In one example, some computer systems limit use of the functions of the computer system by requiring any user to log in to the system under a particular profile, where each profile specifies access privileges. For example, an operating system of a computer system may locally store multiple user profiles, where each user has a log in password and protected files accessible under the profile. In another example, other computer systems are attached via a network to a security server that only allows users that enter network identifiers and passwords to use a computer system. In both systems that use local and network based profiles to control use of a computer system, one of the profiles may be a guest profile that any user accessing the computer system uses to log in and receive limited system use under the guest profile.

In another example, some computer systems limit use of the functions of the computer system by running demonstration software that renders the user interface of the computer system accessing for a single purpose specified by the demonstration software. For example, a vendor may include a computer system in a store-front and run software on that computer system specifically designed to guide the user through a customer service questionnaire, a product demonstration, or other vendor specified purpose, and not display options that allow the user to access any other functions of the underlying computer system.

While profile-based access and vendor-specific software are methods for limiting some users from accessing the full functions of a computer system provide, these methods are limited. In particular, profile-based access is limited because it requires that a user have administrator access to create a profile, it requires that each user log in under a particular profile and that a user log out to switch between profiles and that if a guest profile is offered, that a guest know that they can log in under the guest profile. Further, under a guest log in, the user is typically able to access all applications and files that are not specifically password protected. Further, vendor-specific software is limited because it limits the user to the demonstration or customer service provided by the software, is expensive because it is specified for a particular vendor, and blocks the vendor from providing customer access to any other applications accessible at the computer system. In many situations, however, with both personal computers in a home, network computers within an office, and terminal computers within a store-front, it would be advantageous to provide any user with access to a limited selection of the applications already accessible to the computer system without requiring a guest log in or running an expensive vendor-specific software application, while still allowing authorized users full, normal access to the computer system.

In view of the foregoing limitations, it would be advantageous to provide a method, system, and program for enabling an authorized user to select a link or enter other input to switch the computer system to a selective lock mode, wherein in selective lock mode the display interface includes a selective lock folder of a selection of available application links from among all the applications available at the computer system, such that any user accessing the computer system in selective lock mode is able to use any of the applications with application links without having to log in. In addition, it would be advantage to provide a method, system, and program for enabling an authorized user to easily select the “all access” applications by dragging application links into the selective lock folder and for enabling authorized users to trigger the selective lock mode by selecting an selective lock icon or by designating settings for automatically triggering the selective lock mode, such as on user log out. Further, it would be advantageous to provide a method, system, and program for enabling an authorized user to easily select to return to normal mode by selecting an unlock icon or entering another input that triggers a password prompt sequence, such that authorized users are in control of placing the computer system in and out of selective lock mode, but all other users receive the benefit of access to a selection of applications without a log in under a particular profile.

### SUMMARY OF THE INVENTION

Therefore, the present invention provides for improved data processing system and in particular provides an improved method, system, and program for limiting use of a computer system by a non-authorized user. Still more particularly, the present invention provides a method, system, and program for allowing any computer users access to use only a selection of the available applications at a computer system without a system log in.

In one embodiment, a computer system operates in normal mode where all applications and files are accessible to an authorized user, where an authorized user enters a required log in to access all applications. When a trigger to change the control access from normal mode to selective lock mode is detected, access to the applications and files is blocked and the content within the user interface is cleared to initiate the selective lock mode. Next, content is added to the user interface including a folder with only a selection of the applications each accessible through a separate selectable link, where the selectable links are designated in the particular folder by an authorized user during normal mode. During selective lock mode, any user may only select to open one of the selection of applications by selecting a displayed selectable link for the application. Responsive to a selection of a selectable link, a wrapper function is called that opens the application, wherein any user is enabled to fully access only the wrappered application and the wrapper blocks access to the remainder of the computer system, such that during selective lock mode any user is presented with access, without first logging in, to a fully functioning version of each of the selection of applications designated by the authorized user in the particular folder.

During selective lock mode, an authorized user may request to switch to normal mode by triggering the switch and entering a password that indicates authorization to access the computer system in normal mode. In particular, a display interface during the selective lock mode may include a selectable object, the selection of which triggers the password authorization prompt to switch from selective lock mode to normal mode.

The trigger to change access from normal mode to selective lock mode may be detected from a user selection of a selective lock icon or from an automatic trigger if a setting for automatically triggering the change to selective lock mode is met. For example, a setting may specify an idle time at which selective lock mode is triggered or that a user log out triggers selective lock mode.

Additionally, an authorized user may specify a selection of secondary applications. During selective lock mode, a wrapper function is called to open each of the selection of secondary applications, but a selectable link for the application is not included in the user interface during selective lock mode for selection by a non-authorized user.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting one embodiment of a computer architecture implemented in a computer system;

FIG. 3 is a block diagram depicting the process performed by a selective lock application in selective lock mode;

FIG. 4 is a block diagram depicting the components of a selective lock application;

FIG. 5 is an illustrative diagram depicting a user interface in which a selective lock folder icon and selective lock trigger icon are displayed while the system is operating in normal mode

FIG. 6 is an illustrative diagram depicting a user interface during selective lock mode;

FIG. 7 is an illustrative diagram depicting a user interface during selective loc mode when a user has selected to return to normal mode and entered a password to authorize the switch; and

FIG. 8 is a high level logic flowchart depicting a process and program for controlling a selective lock application, in accordance with the method, system, and program of the present invention

### DETAILED DESCRIPTION OF THE PREFERRED EMBODIMENT

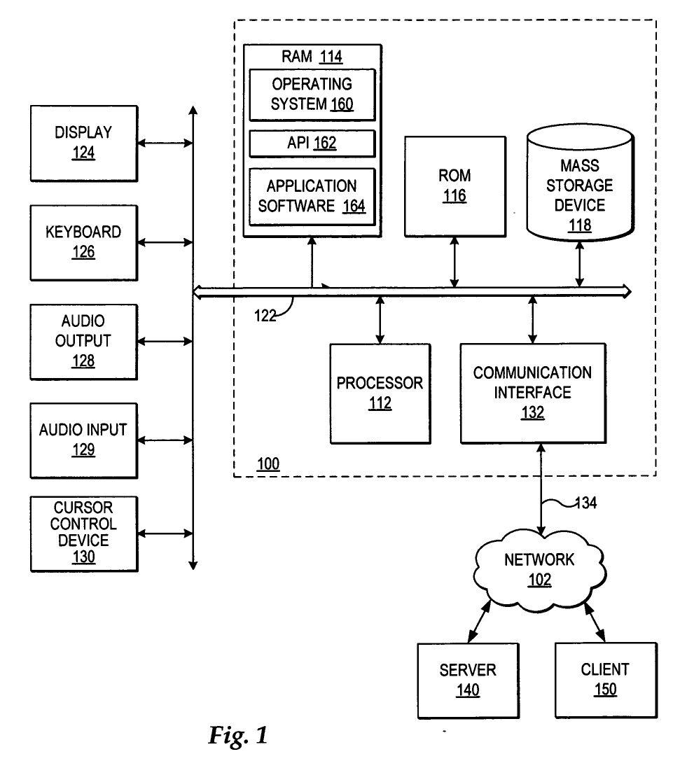

Referring now to the drawings and in particular to FIG. 1, there is depicted one embodiment of a computing system through which the present method, system, and program may be implemented. The present invention may be executed in a variety of systems, including a variety of computing systems and electronic devices.

Computer system 100 includes a bus 122 or other communication device for communicating information within computer system 100, and at least one processing device such as processor 112, coupled to bus 122 for processing information. Bus 122 preferably includes low-latency and higher latency paths that are connected by bridges and adapters and controlled within computer system 100 by multiple bus controllers. When implemented as a server system, computer system 100 typically includes multiple processors designed to improve network servicing power.

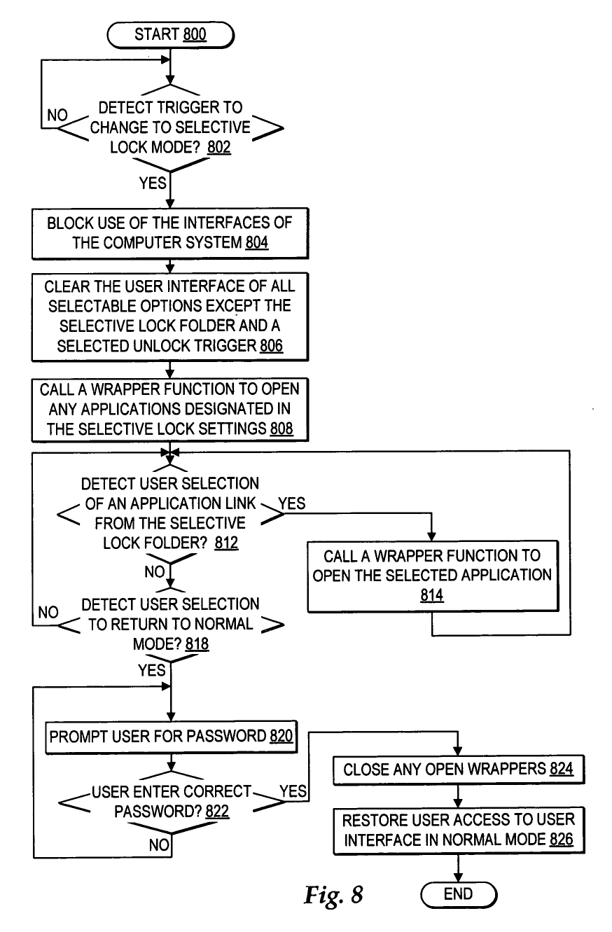

Processor 112 may be a general-purpose processor such as IBM's PowerPC (PowerPC is a registered trademark of International Business Machines Corporation) processor that, during normal operation, processes data under the control of an operating system 160 and application software 164 accessible from a dynamic storage device such as random access memory (RAM) 114. Although not depicted, operating system 160 and application software 164 may also be accessible from static storage device such as Read Only Memory (ROM) 116. The operating system 160 facilitates a user interface via at least one input and output device. For example, operating system 160 may facilitate a graphical user interface (GUI) via a display 124 for output of graphical images and a cursor control device 130 for facilitating user inputs through the selection of a positioned a cursor within display 124. In one embodiment, application software 164 contains machine executable instructions that when executed on processor 112 carry out the operations depicted in the flowchart of FIG. 8 and other operations described herein. Alternatively, the steps of the present invention might be performed by specific hardware components that contain hardwired logic for performing the steps, or by any combination of programmed computer components and custom hardware components. Additionally, RAM 114 may include an application programming interface (API) 162 or other interface that provides extensions to enable application developers to develop application software 164 that extend the functionality of operating system 160.

The present invention may be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote computer such as a server 140 to requesting computer system 100 by way of data signals embodied in a carrier wave or other propagation medium via a network link 134 (e.g. a modem or network connection) to a communications interface 132 coupled to bus 122. Communications interface 132 provides a two-way data communications coupling to network link 134 that may be connected, for example, to a local area network (LAN), wide area network (WAN), or directly to an Internet Service Provider (ISP). In particular, network link 134 may provide wired and/or wireless network communications to one or more networks.

Network link 134 in turn provides data communication services through network 102. Network 102 may refer to the worldwide collection of networks and gateways that use a particular protocol, such as Transmission Control Protocol (TCP) and Internet Protocol (IP), to communicate with one another. Network link 134 and network 102 both use electrical, electromagnetic, or optical signals that carry digital data streams. The signals through the various networks and the signals on network link 134 and through communication interface 132, which carry the digital data to and from computer system 100, are exemplary forms of carrier waves transporting the information.

When implemented as a server system, computer system 100 typically includes multiple communication interfaces accessible via multiple peripheral component interconnect (PCI) bus bridges connected to an input/output controller. In this manner, computer system 100 allows connections to multiple network computers, such as client 150, via network 102.

In addition, computer system 100 typically includes multiple peripheral components that facilitate communication. These peripheral components are connected to multiple controllers, adapters, and expansion slots coupled to one of the multiple levels of bus 122. For example, an audio output device 128 and audio input device 129 are connectively enabled on bus 122 for controlling audio outputs and inputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

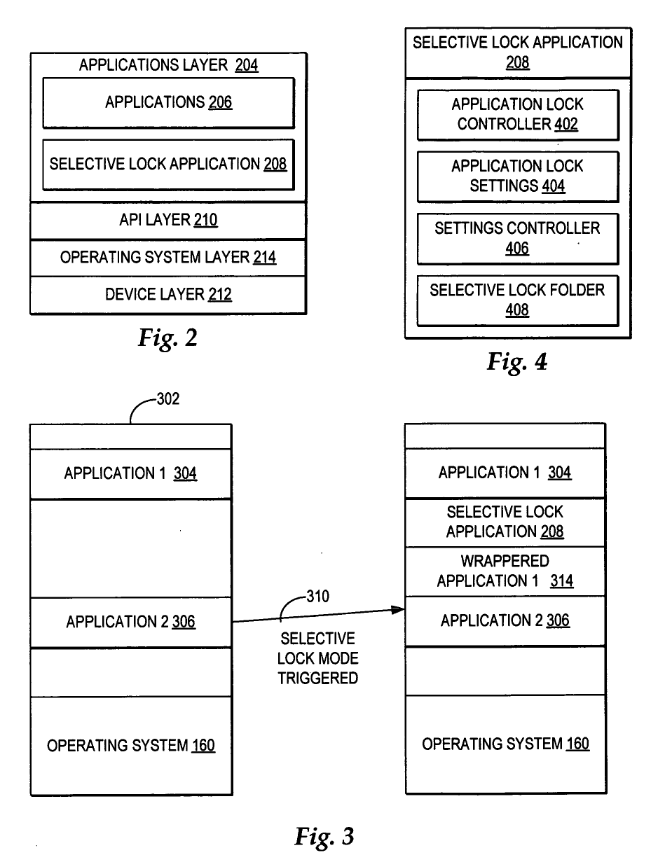

Referring now to FIG. 2, a block diagram illustrates one embodiment of a computer architecture implemented in a computer system. As illustrated, a device layer 212, including the peripherals depicted in FIG. 1, such as display device 124, and device drivers for each peripheral. An operating system layer 214 includes at least one operating system, such as operating system 160, that directs the device drivers in device layer 212 according to instructions received from currently running applications in applications layer 204 according to programming calls designated by APIs in API layer 210. In the example, applications layer 204 may be distributed across RAM 114, mass storage device 118 and other memory systems within computer system 100. Although not depicted, additional layers may include middleware layers and network architecture layers. Further, it will be understood that other computer architectures may implement the present invention.

In the example, for purposes of describing the present invention, applications layer 204 includes multiple applications accessible to the computer system represented by application 206 and a selective lock application 208. In addition, it will be understood that applications layer 204 may include additional types of application software.

Applications 206 includes applications that are selectable, individually, for use by a user. In a normal operating mode, a user authorized to use computer system 100 by operating system 160 is allowed access to use any of applications 206. Selective lock application 208 is an application that places the computer system in selective lock mode and locks the user interface from any user access to any applications or files, except those applications included in a particular selective lock folder displayed within an output interface of device layer 212. Thus, when selective lock application 208 is running the selective lock mode, any user can only choose to run a designated selection of applications 206. As will be further described, selective lock application 208 detects user selection of one of the designated selection of applications and calls a wrapper that opens the selected application to allow the user to access the full functionality of the application, but limits accesses to applications or files outside the wrappered application.

It is important to note that throughout the description of the invention, the term authorized user is used in association with users who are able to use a computer system when it is in a normal mode, meaning in a mode not controlled by selective lock application 208 in selective lock mode. An authorized user may include, but is not limited to, a user who has access to the computer system after entering a user identifier and password or selecting a particular profile. An authorized user may include those users with access to the password that enables changing a system from selective lock mode back to normal mode. In contrast, a non-authorized user is one who uses the computer system while it is in selective lock mode. An authorized user and non-authorized user may be physically the same user, using a computer system in different capacities or different people.

With reference now to FIG. 3, a block diagram illustrates the process performed by a selective lock application in selective lock mode. In the example, a memory 302 is first illustrated during normal operating mode, where “application 1” at reference numeral 304 and “application 2” at reference numeral 306 are loaded into memory 302 and running. In addition, memory 302 includes operating system 308. When the selective lock mode provided by selective lock application 208 is triggered, as illustrated at reference numeral 310, selective lock application 208 is loaded into memory 302 and the applications previously running during normal mode are closed or at least hidden from user access.

Referring now to FIG. 4, a block diagram illustrates the components of selective lock application 208. In particular, selective lock application 208 includes an application lock controller 208 that controls the selective lock mode. When a selective lock mode is triggered (e.g., a user selects a selective lock icon or a setting triggering automatic selective lock mode is met), application lock controller 402 blocks access via device layer 212 or other access points, to computer system 100. In one example, in blocking access during selective lock mode, application lock controller 402 may trigger commands of operating system 160 that prohibit access to any application or file unless a request to the application is made by application lock controller 402. In the example, “application 1” at reference numeral 304 and “application 2” at reference numeral 306 remain in memory, but are not accessible while application lock controller 402 is running. In an alternate embodiment, application lock controller 402 may request to clear memory 302 or perform other processes to block user access to applications and files accessible to computer system 100.

In particular, selective lock application 208 includes a settings controller 406 that an authorized user can run and that prompts the authorized user to select preferences for triggering the selective lock mode and preferences for performance during selective lock mode. In particular, an authorized user may select preferences that are stored as application lock settings 404 as to the amount of time that a system may remain idle before automatically triggering application lock controller 402 and whether an authorized user log out should automatically trigger application lock controller 402. In addition, settings controller 406 may direct an authorized user to select a preference as to the location and display attributes of selective lock folder 408 that specifies those applications that are to be accessible to any user during selective lock mode. Further, settings controller 406 may direct a user to select which applications are to be included in selective lock folder 408 by selecting from an application directory, for example. In particular, while selective lock folder 408 is illustrated as a component of selective lock application 208, selective lock folder 408 may be any folder located on any accessible system that is designated in application lock settings 404 as the folder where selected application links for selective lock mode are located. Further, selective lock folder 408 may be displayed within the user interface in normal mode and selective lock mode, or only during selective lock mode. Additionally, settings controller 406 may guide an authorized user to select applications to place in selective lock folder 408 or an authorized user may place links to selected applications in selective lock folder 408 through any of the methods enabled by operating system 160 for placement of links, such as a dragging and dropping icons that open applications into selective lock folder 408.

In addition, in blocking access during selective lock mode, application lock controller 402 directs operating system 160 to clear the contents within a user interface of any selectable display objects other than selective lock folder 408, the selectable application links included in selective lock folder 408, and a selectable unlock icon. Selection of the selectable unlock icon, as will be further described, triggers applications lock controller 402 to control a password prompt required to return to normal mode. As an alternative to displaying a selectable unlock icon, a user may enter a key sequence of a particular voice command to trigger the password prompt.

Additionally, an authorized user may select in application lock settings 404, through settings controller 406, at least one secondary applications that is enabled to run during selective lock mode other than the operating system, but which is not included in the selective lock folder. For example, a user may choose to enable a screen saver application to run during selective lock mode as a secondary application, but would not want non-authorized users to have access to the screen saver application to change its settings. After blocking access during selective lock mode, application lock controller 402 may trigger a wrapper function to open secondary applications designated in application lock settings 404 to run but not be accessible to the user.

From among the selectable application links in selective lock folder 408, a non-authorized user may select to open an application. For purposes of example, the non-authorized user selects a link associated with application 1 from selective lock folder 408. Application lock controller 402 calls a wrapper function that opens application 1. The wrapper fimction allows the non-authorized user full access to the functionality of application 1, but no memory accesses beyond wrappered application 1. FIG. 3 illustrates that memory includes wrappered application 1 at reference numeral 314. In particular, according to an advantage, by calling a wrapper function to open a selected application, the application is bounded in memory so that the non-authorized user is allowed full access to the functions of application, but blocked from accesses to other applications and files outside the wrappered application.

Next, if an authorized user selects to unlock the selective lock mode and return to normal mode, by selecting an unlock icon or through other input, application lock controller 402 prompts the authorized user for a password. If the authorized user enters the required password, then application lock controller 402 closes wrappered applications and may redirect the operating system to restore the memory to the system status before the selective lock mode initiated. A password may include alphanumeric entries, voice entries, biometric entries, and other input that identifies the user as authorized to unlock the screen.

It is important to note that the components of selective lock application 208 may be included as functional components of operating system 160, rather than as a stand-alone application or may be included as functional components of a Java applet or other component triggered from a web site. Further, it is important to note that the components of selective lock application 208 may be distributed across multiple computer systems and may be accessed by a computer system from a server system, such as server 140 in FIG. 1.

In one example of the advantage of the invention, an authorized user may trigger selective lock application 208 and without having to log out from a network connection, limit other non-authorized users to access to selected applications, but not the underlying network access.

In another example of the advantage of the invention, a network may trigger selective lock application 208 automatically on detecting a user log out from a network controlled system, such that when an authorized user is not logged in at a network controlled computer system, a selection of applications are displayed and selectable by any other non-authorized user accessing the computer system.

In yet another example of an advantage of the invention, an authorized user may loan a laptop to a non-authorized colleague where the colleague needs the laptop to give a multimedia presentation. The authorized user may add the multimedia application needed by the colleague to selective lock folder 408, trigger selective lock mode and hand off the laptop, assured that the colleague can use the computer system for the specified purpose, without access to other applications and files.

In another example, a computer vendor may add multiple applications that the vendor would like for non-authorized customers to be able to try out on a computer system to selective lock folder 408 and trigger selective lock mode so that customers can choose to run the actual full version of an application that the customer may be interested in purchasing, without allowing customers access to the complete underlying functions of the computer system. Further, a computer vendor may add demonstration applications that block the user from accessing other functions of the computer system to selective lock folder and open that demonstration application while selective lock application 208 is controlling the computer system in selective lock mode, to rely on the security features of selective lock application 208 to block user accesses to the underlying system, rather than relying on outdated vendor-specific software that may not include updates to security holes.

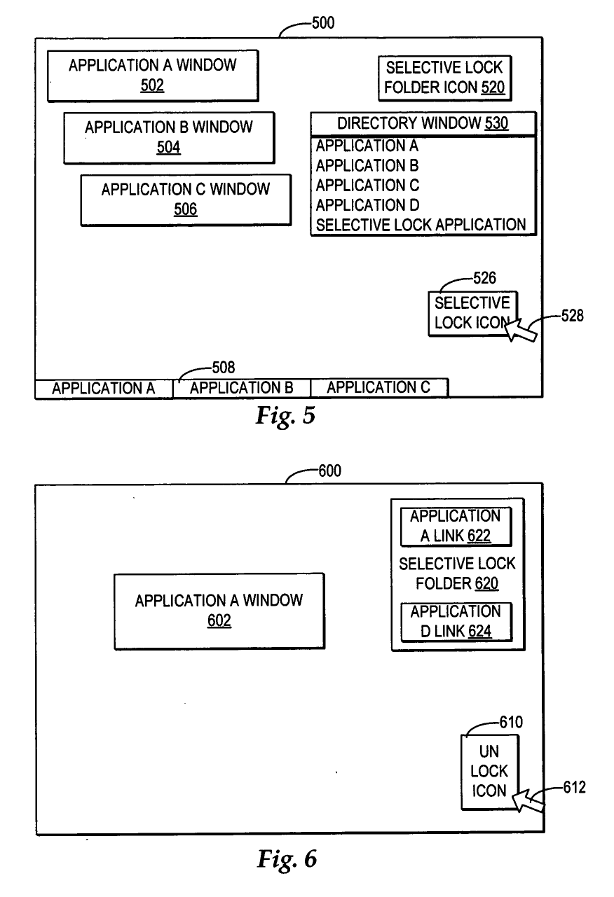

With reference now to FIG. 5, an illustrative diagram shows a user interface in which a selective lock folder icon and selective lock trigger icon are displayed while the system is operating in normal mode. As illustrated, a user interface 500 includes multiple windows open as interfaces for multiple open applications. In the example, application A window 502 corresponding to an Application A, application B window 504 corresponding to an Application B, and application C window 506 corresponding to an Application C, are open within user interface 500. In addition, the operating system provides an application bar 508 that includes selectable buttons for opening and closing application A window 502, application B window 504, and application C window 506, within user interface 500. Further, a directory window 530 illustrates the applications accessible at the computer system, when the computer system is operating in a normal mode.

Additionally, user interface 500 includes an icon 520 representing selective lock folder 408 showing the selectable links included in the selective lock folder. In one embodiment, an authorized user may drag and drop a listing in directory window 530 onto icon 520 to create a selectable link to the application in selective lock folder 408. In addition, an authorized user may select to places copies of application icons or other display objects that trigger the start of an application onto icon 520 for placement in selective lock folder 520. As will be further described with reference to FIG. 6, selective lock folder 408 currently includes links for application A and application D.

User interface also includes a selective lock icon 526, that when selected by the authorized user through the positioning of cursor 528, triggers selective lock application 208. It will be understood that a user may also trigger selective lock application 208 by selecting the listing for selective lock application 208 in directory window 530. Additionally, selective lock application 208 may be automatically triggered if settings for automatic triggering are met.

Referring now to FIG. 6, an illustrative diagram shows a user interface during selective lock mode. As illustrated, a user interface 600 during selective lock mode, as compared with user interface 500 during normal mode, only includes a selective lock folder window 620 representing selective lock folder 408 with a selectable link 622 associated with application A and a selectable link 624 associated with application D. Responsive to a non-authorized user selection of application A, selective lock application 208 calls a wrapper function that opens application A, as illustrated by application A window 602 within user interface 600 through which a user has full access to the functions of application A.

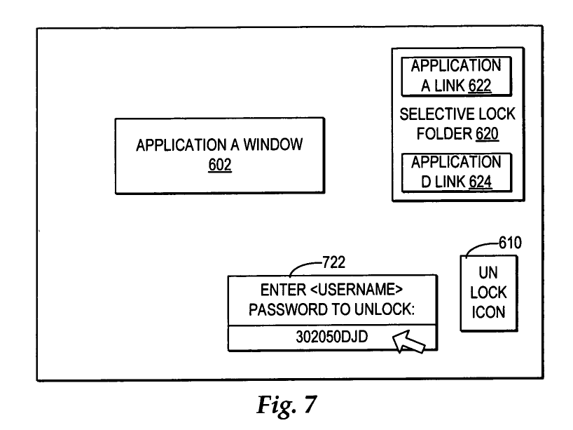

Additionally, user interface 600 includes an unlock icon 610. A user, and in particular an authorized user, may select unlock icon 610 by positioning cursor 612 over unlock icon 610 and entering an input. Responsive to a user selection of unlock icon 610, selective lock application 208 triggers a password entry window, as illustrated in FIG. 7. In particular, in FIG. 7, a user interface 700, still in selective lock mode, includes a window 722 into which a user, identified by <username>, may enter a password associated with the username. In the example, the password is an alphanumeric entry, however, it will be understood that other types of password inputs may be implemented. In one embodiment, responsive to entry of an authorized password, selective lock application 208 closes any application windows and may restore the system settings that control the user interface to appear as user interface 500 appears FIG. 5, prior to selective lock-mode. It will be understood that in other embodiments, the user interface, upon return to a normal mode after selective lock mode, may appear different ways. For example, closing selective lock application 208 alone may allow the operating system to return to a default screen mode. In addition, it is important to note that user interface need not include unlock icon 610, but that through other input an authorized user may select to change from selective lock mode to normal mode. Further, it is important to note that rather than display unlock icon 610, during selective lock mode, the user interface may include password entry window 722 and selective lock folder window 620.

Referring now to FIG. 8, a high level logic flowchart depicts a process and program for controlling a selective lock application, in accordance with the method, system, and program of the present invention. As illustrated, the process starts at block 800 and thereafter proceeds to block 802. Block 802 depicts a determination whether a trigger to start the selective lock mode is detected. In particular, a trigger may include a user selection to open the selective lock application or an automatic trigger when a selective lock setting is met. If a trigger is detected, then the process passes to block 804.

Block 804 illustrates the selective lock application blocking use of the interfaces of the computer system. Next, block 806 depicts the selective lock application clearing the content within a user interface of all selectable options except the selective lock folder and a selected unlock trigger, and the process passes to block 808. In particular, in clearing the content within the user interface, the selective lock application may overlay the display interface layer during normal mode with a blank screen and add new content to the user interface including the selective lock folder and selected unlock trigger. In addition, in particular, the selective lock settings may specify whether a trigger icon, password window, or other selectable display object for triggering switching from selective lock mode are to be displayed during selective lock mode.

Block 808 depicts calling a wrapper function to open any applications designated in the selective lock settings as applications to open during selective lock mode, but not include the selective lock folder for user access. Next, block 812 illustrates a determination by the selective lock application whether a user selection from a selectable application link in the selective lock folder is detected. If a user selection from a selectable application link in the all access folder is detected, then the process passes to block 814. Block 814 depicts calling a wrapper function to open the selected application, and the process returns to block 812.

Otherwise, at block 812, if no user selection from a selectable application link is detected, then the process passes to block 818. Block 818 depicts a determination by the selective lock application whether a user selection to unlock or change from selective lock mode to normal mode is detected. If no user selection to unlock is detected, then the process returns to block 812. If a user selection to unlock is detected, then the process passes to block 820. Block 820 depicts prompting the user for a password. Next, block 822 illustrates a determination by the screen lock application whether a correct password is entered. If a correct password is not entered, then the process returns to block 820. If a correct password is entered, then the process passes to block 824. Block 824 depicts closing any open wrappers, and thus closing any open applications. Next, block 826 illustrates restoring user access to the content within the user interface in normal mode and closing the application lock controller of the selective lock application and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for controlling access to a plurality of applications at a computer system, comprising:
responsive to detecting a trigger to change control access at said computer system from a normal mode to a selective lock mode, blocking access to said plurality of applications and clearing content from a user interface controlled by said computer system, wherein during said normal mode at least one authorized user is enabled to access said plurality of applications by entering a required log in identification;
adding, to said user interface as different content, a particular folder comprising a plurality of selectable links each associated with a separate one from among only a designated selection of said plurality of applications accessible at said computer system, wherein said plurality of selectable links are designated by said authorized user in said same particular folder during normal mode;
responsive to any user selection from said particular folder of a particular selectable link from among said plurality of selectable links, calling a wrapper fuiction to open a particular application associated with said particular selectable link, wherein said wrapper function bounds said particular application and limits accesses outside said particular application, such that during selective lock mode any said user is presented with access, without first logging in, to a fully functioning version of each of said selection of said plurality of applications designated by said authorized user in said particular folder.

2. The method for controlling access to a plurality of applications according to claim 1, further comprising:
responsive to a selection to change control access at said computer system from said selective lock mode to said normal mode, prompting entry of a password to return access to a particular authorized user of all of said plurality of applications.

3. The method for controlling access to a plurality of applications according to claim 2, further comprising:
displaying at least one selectable object in said user interface during said selective lock mode, wherein selection of said at least one selectable object indicates said selection to change control access from said selective lock mode to said normal mode.

4. The method for controlling access to a plurality of applications according to claim 1, wherein said authorized user is enabled to log in at said computer system to access said computer system in normal mode as controlled by at least one of an operating system of said computer system or a network access server for controlling access to said computer system.

5. The method for controlling access to a plurality of applications according to claim 1, further comprising:
detecting said trigger to change control access from said normal mode to said selective lock mode from a selection of a selective lock icon automatically displayed in said user interface during normal mode.

6. The method for controlling access to a plurality of applications according to claim 1, further comprising:
detecting said trigger to change control access from said normal mode to said selective lock mode from detecting at least one setting selected by said authorized user being met, wherein said at least one setting comprises at least one from among a particular idle time triggering said selective lock mode and a user log out triggering said selective lock mode.

7. The method for controlling access to a plurality of applications according to claim 1, further comprising,
calling said wrapper function to open a secondary application from among said plurality of applications designated by said authorized user to be automatically opened during selective lock mode but not included in said particular folder.

8. A system for controlling access to a plurality of applications at a computer system, comprising:
a user interface controlled by said computer system;
a plurality of applications accessible at said computer system, wherein during a normal mode of operation on said computer system at least one authorized user is enabled to access said plurality of applications by entering a required log in identification;
a plurality of selectable links designated by said authorized user in a particular folder within said user interface during normal mode, wherein each of said plurality of selectable links is associated with a separate one from among only a designated selection of said plurality of applications;
a selective lock application, triggered responsive to a request to change control access at said computer system from said normal mode to a selective lock mode, for blocking access to said plurality of applications, clearing content from said user interface, and adding as different content within said user interface said particular folder comprising said plurality of selectable links for selection, wherein any user is only enabled to access said designated selection of said plurality of applications via said plurality of selectable links during said selective lock mode;
said selective lock application for calling a wrapper function to open a particular application associated with a particular selectable link, responsive to any user selection of said particular selectable link from among said plurality of selectable links during selective lock mode, wherein said wrapper function bounds said particular application and limits accesses outside said particular application.

9. The system for controlling access to a plurality of applications according to claim 8, said selective lock means for prompting entry of a password via said user interface to return access to all of said plurality of applications, responsive to detecting a selection to change control access at said computer system from said selective lock mode to said normal mode,.

10. The system for controlling access to a plurality of applications according to claim 9, said selective lock means for enabling display via said user interface of at least one selectable object during said selective lock mode, wherein selection of said at least one selectable object indicates said selection to change control access from said selective lock mode to said normal mode.

11. The system for controlling access to a plurality of applications according to claim 8, wherein said authorized user is enabled to log in at said computer system to access said computer system in normal mode as controlled by at least one of an operating system of said computer system or a network access server for controlling access to said computer system.

12. The system for controlling access to a plurality of applications according to claim 8, said selective lock means for detecting said trigger to change control access from said normal mode to said selective lock mode from a selection by said authorized user of a selective lock icon automatically displayed in said user interface during normal mode.

13. The system for controlling access to a plurality of applications according to claim 8, said selective lock means for detecting said trigger to change control access from said normal mode to said selective lock mode from detecting at least one setting selected by said authorized user being met, wherein said at least one setting comprises at least one from among a particular idle time triggering said selective lock mode and a user log out triggering said selective lock mode.

14. The system for controlling access to a plurality of applications according to claim 8, said selective lock means for calling said wrapper function to open a secondary application from among said plurality of applications designated by said authorized user to be automatically opened during selective lock mode but not included in said particular folder.

15. A program for controlling access to a plurality of applications at a computer system, said program embodied in a computer-readable medium, said program comprising computer-executable instructions which cause a computer to perform the steps of:
responsive to detecting a trigger to change control access at said computer system from a normal mode to a selective lock mode, blocking access to said plurality of applications and clearing content from a user interface controlled by said computer system, wherein during said normal mode at least one authorized user is enabled to access said plurality of applications by entering a required log in identification;
adding, to said user interface as different content, a particular folder comprising a plurality of selectable links each associated with a separate one from among only a designated selection of said plurality of applications accessible at said computer system, wherein said plurality of selectable links are designated by said authorized user in said same particular folder during normal mode;
responsive to any user selection from said particular folder of a particular selectable link from among said plurality of selectable links, calling a wrapper function to open a particular application associated with said particular selectable link, wherein said wrapper function bounds said particular application and limits accesses outside said particular application.

16. The program for controlling access to a plurality of applications according to claim 15, further comprising:
responsive to a selection to change control access at said computer system from said selective lock mode to said normal mode, prompting entry of a password to return access to all of said plurality of applications.

17. The program for controlling access to a plurality of applications according to claim 15, wherein said authorized user is enabled to log in at said computer system to access said computer system in normal mode as controlled by at least one of an operating system of said computer system or a network access server for controlling access to said computer system.

18. The program for controlling access to a plurality of applications according to claim 15, further comprising:
detecting said trigger to change control access from said normal mode to said selective lock mode from a selection by said authorized user of a selective lock icon automatically displayed in said user interface during normal mode.

19. The program for controlling access to a plurality of applications according to claim 15, further comprising:
detecting said trigger to change control access from said normal mode to said selective lock mode from detecting at least one setting selected by said authorized user being met, wherein said at least one setting comprises at least one from among a particular idle time triggering said selective lock mode and a user log out triggering said selective lock mode.

20. The program for controlling access to a plurality of applications according to claim 15, further comprising,
calling said wrapper function to open a secondary application from among said plurality of applications designated by said authorized user to be automatically opened during selective lock mode but not included in said particular folder.
